(19) United States
(12) Patent Application Publication
(10) Pub. No.: US 2026/0303890 A1
(43) Pub. Date: Oct. 1, 2026

(54) INFORMATION PROCESSING

(71) Applicant: Beijing Zitiao Network Technology Co., Ltd., Beijing (CN)

(72) Inventors: Yuting LAN, Beijing (CN); Yang HUO, Beijing (CN); Yi SHEN, Beijing (CN); Xiao YANG, Beijing (CN); Zuotao LIU, Beijing (CN)

(21) Appl. No.: 19/632,249

(22) Filed: Mar. 28, 2026

(30) Foreign Application Priority Data
Mar. 28, 2025 (CN) 2025103891580

(51) Int. Cl. H04N 21/25; G06N 20/00

(52) U.S. Cl. CPC H04N 21/251; G06N 20/00

(57) ABSTRACT

The disclosure relates to information processing. The method proposed herein includes: determining an input feature sequence for a machine learning model based on an object feature representation of a recommendation object and a first user feature representation corresponding to a user in a user sequence which is determined based on users who perform interactions with the recommendation object; generating, based on the input feature sequence, a predicted user feature representation for the recommendation object using the machine learning model to indicate a user who performs an interaction with the recommendation object at a future time; extracting, in response to receiving a recommendation request, a second user feature representation corresponding to an initiating user of the recommendation request; and providing, in response to a similarity between the second user feature representation and the predicted user feature representation satisfying a similarity requirement, the recommendation object to the initiating user.

### CROSS-REFERENCE

The present application claims priority to Chinese Patent Application No. 202510389158.0, filed on Mar. 28, 2025, entitled “METHOD, APPARATUS, DEVICE, AND STORAGE MEDIUM FOR INFORMATION PROCESSING”, the entirety of which is incorporated herein by reference.

### FIELD

Example embodiments of the present disclosure generally relate to a field of computer technologies, and in particular, to information processing.

### BACKGROUND

Content recommendation is a personalized information distribution technology. A cold start problem of content recommendation is one of the challenges when introducing new content (such as an article, a commodity, a video, etc.), introducing a new user, or processing sparse interaction data in a recommendation system. For example, when the new content is first added into a content recommendation system, due to the lack of sufficient user interaction data (such as clicks, browsing, likes, etc.) it is difficult for the content recommendation system to effectively recommend the new content to a target user. This results in the new content being difficult to obtain user feedback due to insufficient impressions, and the lack of feedback further compresses the impression opportunities of the new content, thus forming a vicious circle.

### SUMMARY

In a first aspect of the present disclosure, a method for information processing is provided. The method includes: determining, in response to there being a user sequence associated with a recommendation object, an input feature sequence for a machine learning model based on at least one object feature representation of the recommendation object and at least one first user feature representation corresponding to at least one user in the user sequence, where the user sequence is determined based on users who perform interactions with the recommendation object; generating, based on the input feature sequence, a predicted user feature representation for the recommendation object using the machine learning model, where the predicted user feature representation is used to indicate a user who performs an interaction with the recommendation object at a future time; extracting, in response to receiving a recommendation request, a second user feature representation corresponding to an initiating user of the recommendation request; and providing, in response to a similarity between the second user feature representation and the predicted user feature representation satisfying a similarity requirement, the recommendation object to the initiating user of the recommendation request.

In a second aspect of the present disclosure, an apparatus for information processing is provided. The apparatus includes: an input feature sequence determination module configured to determine, in response to there being a user sequence associated with a recommendation object, an input feature sequence for a machine learning model based on at least one object feature representation of the recommendation object and at least one first user feature representation corresponding to at least one user in the user sequence, where the user sequence is determined based on users who perform interactions with the recommendation object; a predicted user feature representation generation module configured to generate, based on the input feature sequence, a predicted user feature representation for the recommendation object using the machine learning model, where the predicted user feature representation is used to indicate a user who performs an interaction with the recommendation object at a future time; a user feature representation extraction module configured to extract, in response to receiving a recommendation request, a second user feature representation corresponding to an initiating user of the recommendation request; and a recommendation object provision module configured to provide, in response to a similarity between the second user feature representation and the predicted user feature representation satisfying a similarity requirement, the recommendation object to the initiating user of the recommendation request.

In a third aspect of the present disclosure, an electronic device is provided. The device includes at least one processor; and at least one memory, where the at least one memory is coupled to the at least one processor and stores instructions executable by the at least one processor. The instructions, when executed by the at least one processor, cause the device to perform the method of the first aspect.

In a fourth aspect of the present disclosure, a computer-readable storage medium is provided. The computer-readable storage medium has computer-executable instructions stored thereon, and the computer-executable instructions are executable by a processor to implement the method of the first aspect.

In a fifth aspect of the present disclosure, a computer program product is provided. The computer program product includes computer-executable instructions, where the computer-executable instructions, when executed by a processor, implement the method according to the first aspect of the present disclosure.

Embodiments of the present disclosure may be applied to video-oriented generative recommendation in a cold start scenario. It should be appreciated that the content described in this Summary section is neither intended to limit key or essential features of the embodiments of the present disclosure, nor is it intended to limit the scope of the present disclosure. Other features of the present disclosure will be readily understood through the following description.

### BRIEF DESCRIPTION OF THE DRAWINGS

The foregoing and other features, advantages, and aspects of the embodiments of the present disclosure will become more apparent from the following detailed description taken in conjunction with the accompanying drawings. In the drawings, the same or similar reference numerals refer to the same or similar elements, wherein:

FIG. 1 illustrates a schematic diagram of an example environment capable of implementing the embodiments of the present disclosure;

FIG. 2 illustrates a flowchart of an example process of a method for information processing according to some embodiments of the present disclosure;

FIG. 3 illustrates a schematic diagram of an example of generating a predicted user feature representation according to some embodiments of the present disclosure;

FIG. 4 illustrates a schematic structural block diagram of an apparatus for information processing according to some embodiments of the present disclosure; and

FIG. 5 illustrates a block diagram of an electronic device in which one or more embodiments of the present disclosure may be implemented.

### DETAILED DESCRIPTION OF EMBODIMENTS

Embodiments of the present disclosure will be described in more detail below with reference to the accompanying drawings. Although some embodiments of the present disclosure are shown in the accompanying drawings, it should be understood that the present disclosure may be implemented in various forms and should not be construed as being limited to the embodiments set forth herein; on the contrary, these embodiments are provided for a more thorough and complete understanding of the present disclosure. It should be understood that the drawings and embodiments of the present disclosure are merely for example purposes, and are not intended to limit the protection scope of the present disclosure.

It should be noted that titles of any section/sub-section provided herein are not limiting. Various embodiments are described throughout herein, and any type of embodiments may be included under any section/sub-section. In addition, the embodiments described in any section/sub-section may be combined, in any manner, with any other embodiments described in the same section/sub-section and/or in different section/sub-section.

In the description of the embodiments of the present disclosure, the term “comprising” and similar terms should be understood as openness, that is, “comprising but not limited to”. The term “based on” should be understood as “based at least in part on”. The term “one embodiment” or “the embodiment” should be understood as “at least one embodiment”. The term “some embodiments” should be understood as “at least some embodiments”. Other definitions, both explicit and implicit, may also be included below. The terms “first” and “second” etc. may refer to different or same objects. Other definitions, both explicit and implicit, may also be included below.

The embodiments of the present disclosure may relate to data of a user, obtaining and/or usage of data, etc. These aspects all follow with the corresponding laws, regulations, and related provisions. In the embodiments of the present disclosure, all data collection, obtaining, processing, handling, forwarding, and usage, etc., are conducted with knowledge and consent of the user. Accordingly, when implementing the embodiments of the present disclosure, types, usage scopes, usage scenarios, etc., of the data or information that may be involved should be informed to the users, and obtain user authorization in an appropriate manner according to the relevant laws and regulations. A specific notification and/or authorization manner may vary according to the actual situations and application scenarios, and the scope of the present disclosure is not limited in this regard.

The solutions in the present specification and embodiments, if involving personal information processing, will be processed on the premise that there is a legal basis (for example, the consent of the personal information subject is obtained, or it is necessary to perform a contract, etc.), and will only be processed within the scope of regulations or agreements. If the user refuses to process personal information other than the necessary information required for the basic functions, it will not affect use of basic functions by the user.

As briefly described above, in the content recommendation scenario, the cold start problem is one of the challenges that the recommendation system has to face when introducing new content, registering new users, or processing sparse interaction data. For example, in a video recommendation scenario, solving the cold start problem directly determines whether high-quality new content can be distributed more, provides key feedback for creators, and ultimately realizes active content creation by the creators. Traditional recommendation systems are deeply troubled by the cold start problem due to their excessive dependence on historical interaction data. For example, lack of impression and feedback of the new content leads to impairment of fairness, interactivity, diversity, etc., of the recommendation system.

Taking the video recommendation scenario as an example, a high-quality new video uploaded by a creator may be buried due to insufficient initial traffic. Even if the new video has the potential to become popular content, it is difficult for a recommendation algorithm to accurately evaluate its content value because of absence of user interaction data, resulting in distribution efficiency far lower than that of mature content. This “cold start problem” may not promote the enthusiasm of content creators and reduce the efficiency and effectiveness of content distribution in video platforms.

It is worth emphasizing that the cold start problem has multi-dimensional complexity. For example, it is difficult to construct an interest model for cold start of a new user due to lack of behavior history, it is difficult to evaluate quality for cold start of new content due to lack of interaction data, and a model fails for a sparse interaction scenario (such as a long-tail content field) due to insufficient data density. These three types of problems are intertwined and together constitute a major obstacle for the recommendation systems to evolve towards higher accuracy and wider coverage. How to break through this bottleneck has become an urgent technical issue.

The inventors have found in research that Lookalike algorithms provide a possible solution to the cold start problem of new content. Different from the traditional recommendation algorithm from the perspective of the user, the lookalike algorithm constructs a user expansion mechanism for the recommendation object (which may also be referred to as recommendation content) from the perspective of the recommendation object. Specifically, for each recommendation object, the lookalike algorithm may extract common features of seed users (for example, users who have performed interactions with the recommendation object) of the recommendation object. Then, based on these common features, the lookalike algorithm searches users with similar features (which may also be referred to as similar users) in a larger user group for users, and then provides the recommendation object to these similar users to expand users of the recommendation object. However, in a practical application process, limited to the number and quality of seed users in the cold start scenario, it is difficult for the traditional lookalike algorithm to extract effective common features, and thus it is difficult to accurately find similar users.

In view of this, the embodiments of the present disclosure provide a solution for information processing. According to this solution, first, in response to there being a user sequence associated with a recommendation object, an input feature sequence for a machine learning model is determined based on at least one object feature representation of the recommendation object and at least one first user feature representation corresponding to at least one user in the user sequence, where the user sequence is determined based on users who perform interactions with the recommendation object. Then, a predicted user feature representation for the recommendation object is generated using the machine learning model based on the input feature sequence, where the predicted user feature representation is used to indicate a user who performs an interaction with the recommendation object at a future time. Next, in response to receiving a recommendation request, a second user feature representation corresponding to an initiating user of the recommendation request is extracted. Then, the recommendation object is provided to the initiating user of the recommendation request in response to a similarity between the second user feature representation and the predicted user feature representation satisfying a similarity requirement.

It may be understood more clearly through the following description that, different from the lookalike algorithm, the solution of the present disclosure proposes a next user prediction algorithm, which makes it more suitable for the cold start problem. Specifically, the solution of the present disclosure no longer simply extracts common features from the seed users of the recommendation object, but determines, by means of a machine learning model (such as a Transformer architecture based generative model), a user feature representation (i.e., a predicted user feature representation) that a future potential user (for example, a user who may perform an interaction with the recommendation object in the future, such a user may also be referred to as a next user predicted by the recommendation object) of the recommendation object based on user feature representations (such as the first user feature representation) of the seed users (for example, users who perform interactions with the recommendation object) of the recommendation object (such as new content) and the object feature representation of the recommendation object. Compared with the traditional solution of extracting common features from the seed users of the recommendation object, the solution of the present disclosure uses the machine learning model to dig potential associations and complex patterns between the first user feature representations and between the first user feature representations and the object feature, thereby generating the predicted user feature representation with higher accuracy. In this way, even if the recommendation object has only a small number of seed users or quality of the seed users is not good, the solution of the present disclosure can still generate the predicted user feature representation with relatively high precision, and thus still able to accurately determine similar users from a user group (such as an initiating user of the recommendation request).

In this way, the solution of the present disclosure solves the problem of poor applicability of the lookalike algorithm in the cold start problem, thereby enabling user expansion for new content and improving the capability of the recommendation system to deal with the cold start problem.

Various example implementations of this solution will be described in detail below in further conjunction with the accompanying drawings.

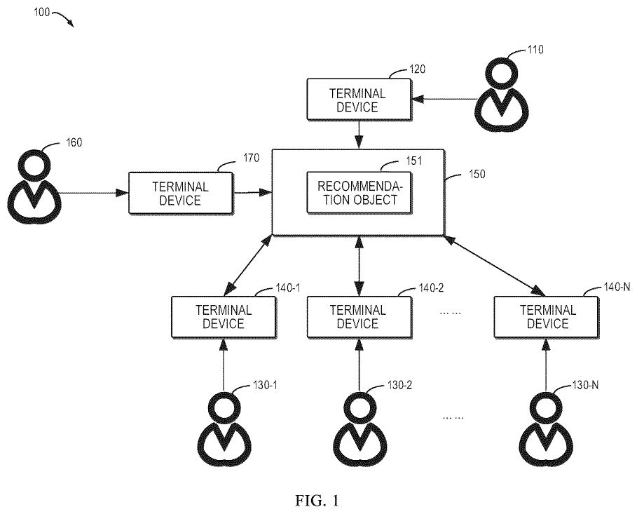

FIG. 1 illustrates a schematic diagram of an example environment 100 capable of implementing the embodiments of the present disclosure. In the environment 100, a user 110 may be a provider of a recommendation object 151. For example, in a video recommendation scenario, the recommendation object 151 may be a video, and the user 110 may be an author of the video. The user 110 may create and manage the recommendation object 151 through an associated terminal device 120.

In the environment 100, users 130-1 to 130-N may be users who have performed interactions with the recommendation object 151. For example, in the video recommendation scenario, the users 130-1 to 130-N may be audiences of a video, where N is a positive integer. The users 130-1 to 130-N may watch the video and interact with the video through their associated terminal devices 140-1 to 140-N respectively, here the interactions include but are not limited to liking, commenting, and/or forwarding, and so on. For the convenience of discussion, the users 130-1 to 130-N are also collectively or individually referred to as a user 130, and the terminal devices 140-1 to 140-N are also collectively or individually referred to as a terminal device 140 below.

In the environment 100, the terminal device 120 and the terminal device 140 may communicate with a content recommendation system 150 through communication means such as a network. The content recommendation system 150 may be an application, a website, a web page, and other accessible platforms. In the video recommendation scenario, the terminal device 120 and the terminal device 140 may be installed with applications for accessing the content recommendation system 150, or the terminal device 120 and the terminal device 140 may access the content recommendation system 150 in any suitable manner to watch or manage videos in the content recommendation system 150.

In the environment 100, a user 160 may be a user who has not performed an interaction with the recommendation object 151. The user 160 may send a recommendation request to the content recommendation system 150 through an associated terminal device 170. The content recommendation system 150 may be configured to select whether to provide the recommendation object 151 to the user 160 based on a corresponding policy.

It should be noted that the recommendation object 151 is described above by taking the video recommendation scenario as an example, but this does not constitute a limitation to the present disclosure. For example, in some applications, the recommendation object 151 may also be live content, a commodity, a service, an advertisement, etc., which may be determined according to actual needs.

In the environment 100, the terminal device 120, the terminal device 140, and the terminal device 170 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination of the foregoing, including accessories and peripherals of these devices or any combination thereof. In some embodiments, the terminal device 120, the terminal device 140, and the terminal device 170 may also support any type of interface for a user (such as “wearable” circuit, etc.).

In the environment 100, the content recommendation system 150 may be deployed in any type of server device. The server device may be a standalone physical server, a server cluster composed of a plurality of physical servers, or a distributed system, or may be a cloud server that provides basic cloud computing services such as cloud services, cloud databases, cloud computing, cloud functions, cloud storages, network services, cloud communications, middleware services, domain name services, security services, content distribution networks, and big data and artificial intelligence platforms and the like. The server device may include, for example, a computing system/server, such as a mainframe, an edge computing node, a computing device in a cloud environment, and so on.

It should be appreciated that the structures and functions of the various elements in the environment 100 are described for example purposes only, without suggesting any limitation to the scope of the present disclosure.

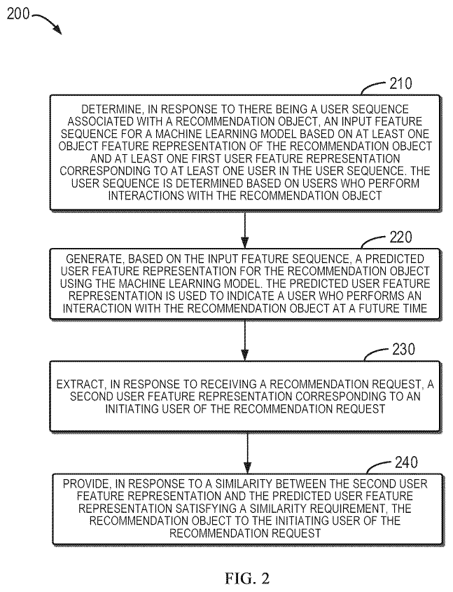

FIG. 2 illustrates a flowchart of an example process 200 of a method for information processing according to some embodiments of the present disclosure. The process 200 may be implemented at the content recommendation system 150.

Referring to FIG. 2, at block 210, in response to there being a user sequence associated with a recommendation object, the content recommendation system 150 determines an input feature sequence for a machine learning model based on at least one object feature representation of the recommendation object and at least one first user feature representation corresponding to at least one user in the user sequence. The user sequence is determined based on users who perform interactions with the recommendation object.

At block 220, the content recommendation system 150 generates, based on an input feature sequence 310, a predicted user feature representation for the recommendation object using the machine learning model. The predicted user feature representation is used to indicate a user who performs an interaction with the recommendation object at a future time.

As an example, the recommendation object may be an entity that the content recommendation system 150 wants to recommend to the user, and it may be various types of recommendable content. For example, the recommendation object may be any of a video, live content, a commodity, a service, and/or an advertisement, which may be determined according to actual needs, and the embodiments of the present disclosure are not limited thereto.

In some embodiments, the user sequence may be an ordered set determined based on users who have performed interactions with the recommendation object. In some embodiments, the interaction performed by the user with the recommendation object may refer to a positive interaction between the user and the recommendation object. For example, in terms of a video, the positive interaction may be an operation such as liking, collecting, and/or commenting performed by a user after browsing the video. For the video, provided that 100 users have watched the video and liked it, the content recommendation system 150 may rank the 100 users based on a corresponding ranking policy (for example, a time-based ranking policy), thereby forming a user sequence.

It should be noted that the description of the positive interaction here is only an example, and the positive interaction may be different according to different recommendation objects. For example, for a commodity or a service, the positive interaction may also include but are not limited to an operation such as purchasing.

In some embodiments, the content recommendation system 150 selects, from candidate users who perform the interactions with the recommendation object, a predetermined number of candidate users whose execution times of the interactions satisfy a time requirement to be users in the user sequence.

As an example, the candidate users may be a user group that has already performed interactions with the recommendation object. For example, provided that 100 users have watched the video and liked the recommendation object, the content recommendation system 150 may determine the 100 users as the candidate users.

As an example, the time requirement is a restriction condition used to filter the candidate users. For example, for the candidate users who perform interactions with the recommendation object, the time requirement may indicate that the content recommendation system 150 selects, from these candidate users, the candidate users with the latest execution times of the interaction to be the users in the user sequence. In addition, the predetermined number may be used to further filter the selected candidate users. For example, the predetermined number may indicate an upper limit on the number of users in the user sequence. In some embodiments, if the number of the candidate users who satisfy the time requirement is greater than or equal to the predetermined number, the content recommendation system 150 may take the predetermined number of the candidate users who satisfy the time requirement as the users in the user sequence. If the number of the candidate users who satisfy the time requirement is less than the predetermined number, the content recommendation system 150 may take all the candidate users who satisfy the time requirement as the users in the user sequence.

For example, provided that the predetermined number is 50. If the content recommendation system 150 determines the 100 users described above as the candidate users, the content recommendation system 150 may select the first 50 users with the latest liking times from the 100 users to construct the user sequence. Provided that the content recommendation system 150 only determines 30 candidate users, the content recommendation system 150 may use the 30 users to construct the user sequence.

In this way, the content recommendation system 150 may effectively deal with massive data (including but not limited to massive recommendation objects or massive interacting users of the recommendation objects), thereby reducing computing power consumption. In addition, for the content recommendation system 150 that needs to process a large number of requests in a short period of time, the above filtering manner may also increase system response speed while reducing storage resource occupancy, and improve versatility of the content recommendation system 150.

In some embodiments, for the candidate users being selected to construct the user sequence, the content recommendation system 150 may rank these candidate users based on the time order in which these candidate users perform interactions with the recommendation object.

It should be noted that the above description of the time requirement and the predetermined number is only an example, and does not constitute a limitation to the embodiments of the present disclosure. According to actual needs, the time requirement may also indicate other content, and the predetermined number is not limited to 50.

The description of block 210 and block 220 will be continued below. As an example, the object feature representations may be in one-to-one correspondence with the object features of the recommendation object. The object feature representation may be a vector or a numerical value obtained after the content recommendation system 150 encodes the corresponding object feature. Taking the recommendation object as a video for an example, the object feature of the recommendation object may indicate an identity (ID) of the recommendation object, an application identifier (AID) of the recommendation object, and/or a category of the recommendation object, and so on.

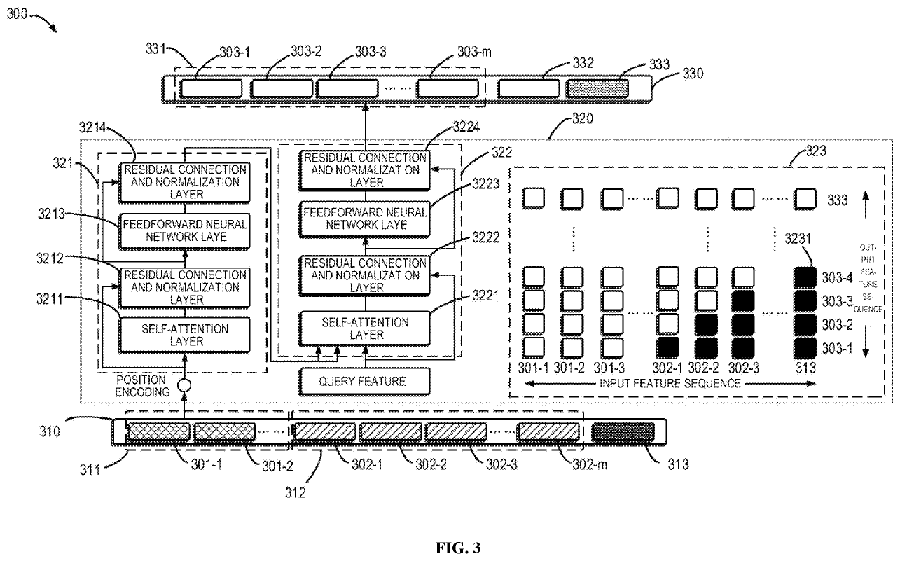

FIG. 3 illustrates a schematic diagram of an example 300 of generating a predicted user feature representation according to some embodiments of the present disclosure.

Referring to FIG. 3, the recommendation object has a plurality of object feature representations 301, and the plurality of object feature representations 301 may include an object feature representation 301-1 corresponding to the ID of the recommendation object, an object feature representation 301-2 corresponding to the AID of the recommendation object, and so on. For the convenience of discussion, the object feature representation 301-1 and the object feature representation 301-2 are also individually or collectively referred to as the object feature representation 301 below. The content recommendation system 150 may encode, through embedding techniques, feature engineering, or any appropriate algorithm, the object features of the recommendation object into computer-processable object feature representations 301 for processing in the machine learning model.

As an example, the first user feature representations may be in one-to-one correspondence with the users in the user sequence. The first user feature representation may be a vector or a numerical value obtained after the content recommendation system 150 encodes user features of the corresponding user. In some embodiments, the user feature may indicate basic information of the user and/or behavioral information of the user, and so on. In addition, the user features may also indicate interaction information (such as liking or collecting) that the user has performed with the recommendation object. Such information may be obtained after requiring for authorization of the user. Similar to the object features, the content recommendation system 150 may encode, through embedding techniques, feature engineering, or any appropriate algorithm, these user features into computer-processable user feature representations, so that the machine learning model may perform association processing on these user feature representations and the object feature representations 301.

Continuing to refer to FIG. 3, as an example, provided that the content recommendation system 150 selects the first m users with the latest liking times from the 100 users described above to construct the user sequence, where m<100 and is a positive integer. Then, the m first user feature representations corresponding to the m users include: a first user feature representation 302-1 corresponding to a first user, a first user feature representation 302-2 corresponding to a second user, . . . , and a first user feature representation 302-m corresponding to an m-th user. For the convenience of discussion, the first user feature representation 302-1, the first user feature representation 302-2 to the first user feature representation 302-m are also individually or collectively referred to as a first user feature representation 302 below.

As an example, the machine learning model 320 may be any appropriate generative machine learning model 320. For example, the machine learning model 320 may be a Transformer architecture based generative model. In addition, the machine learning model 320 may also be a generative model based on other architectures, which will not be listed here in the embodiments of the present disclosure.

As an example, the input feature sequence 310 may be an ordered feature set for the machine learning model 320 that is constructed based at least on the object feature representation 301 and the first user feature representation 302. The input feature sequence 310 will be used as input of the machine learning model 320, and the machine learning model 320 will generate a predicted user feature representation 304 based on this input.

As an example, the predicted user feature representation 304 may be represented in a form of a vector or a numerical value. The predicted user feature representation 304 is an estimation by the machine learning model 320 of user features of a user (which may also be referred to as a potential user) who may perform an interaction with the recommendation object in the future. In some embodiments, the predicted user feature representation 304 is used to describe user features that the potential user of the recommendation object most likely has. In some embodiments, the machine learning model 320 may generate the predicted user feature representation 304 through, for example, an autoregressive generation operation for user feature representation.

As an example, the autoregressive generation operation is a sequence-based data generation method. The autoregressive generation operation assumes that each element (which may also be referred to as a token) in the sequence depends on elements generated before. When generating the predicted user feature representation 304, the machine learning model 320 may gradually predict a next possible user feature representation in an output feature sequence 330 based at least on the object feature representation 301 and the first user feature representation 302 in the input feature sequence 310, until the predicted user feature representation 304 is generated.

It should be noted that the above generation of the predicted user feature representation 304 is only an example, and the machine learning model may also generate the predicted user feature representation 304 through other prediction operations according to actual needs, which will not be listed here in the embodiments of the present disclosure.

In some embodiments, the content recommendation system 150 obtains a first user feature sequence by ranking at least one first user feature representation 302 based on execution time of the interaction. Then, the content recommendation system 150 determines a prefix feature sequence for the first user feature sequence based on at least one object feature representation 301. Then, the content recommendation system 150 determines the input feature sequence based at least on a concatenation of the prefix feature sequence and the first user feature sequence.

Continuing to refer to FIG. 3, the content recommendation system 150 may rank the first user feature representation 302-1, the first user feature representation 302-2 to the first user feature representation 302-m according to the execution time of the interaction from far to near (compared to the current moment), thereby obtaining a first user feature sequence 312. Such a first user feature sequence 312 may indicate a temporal association relationship among a plurality of users. For example, taking the recommendation object as a video for an example, an interaction (e.g., a comment) performed by the second user on the recommendation object may be caused by some interactions (e.g., comments) performed by the first user on the recommendation object before. In this way, the machine learning model 302 may learn a causal relationship among the plurality of users in terms of the interactions with the recommendation object, thereby improving accuracy of the predicted user feature representation 304.

Continuing to refer to FIG. 3, the content recommendation system 150 may arrange the object feature representation 301-1, the object feature representation 301-2, etc. in any appropriate manner to obtain a prefix feature sequence 311. After obtaining the first user feature sequence 312 and the prefix feature sequence 311, the content recommendation system 150 may construct the input feature sequence 310 by attaching the first user feature sequence 312 to the prefix feature sequence 311.

In this way, the content recommendation system 150 may embed the plurality of object feature representations 301 as prefix prompts to make up for limitations of the first user feature sequence 312, thereby achieving multi-modal feature fusion.

In some embodiments, the content recommendation system 150 determines the input feature sequence 310 based on a concatenation of the prefix feature sequence 311, the first user feature sequence 312, and a classification token 313 associated with the machine learning model 320. The classification token 313 is attached to the prefix feature sequence 311 and the first user feature sequence 312. Then, the content recommendation system 150 provides the input feature sequence 310 to the machine learning model 320 as input. The machine learning model 320 performs an autoregressive generation operation for user feature representation based on the prefix feature sequence 311 and the first user feature sequence 312 to generate a second user feature sequence 331 corresponding to the first user feature sequence 312 and a third user feature representation 332 attached to the second user feature sequence 331. Then, the content recommendation system 150 generates the predicted user feature representation 304 based on the classification token 313, the prefix feature sequence 311, the first user feature sequence 312, and the third user feature representation 332.

Continuing to refer to FIG. 3, the content recommendation system 150 may connect the prefix feature sequence 311, the first user feature sequence 312, and the classification token 313 in sequence to construct the input feature sequence 310. As described above, the machine learning model 320 may generate the predicted user feature representation 304 by predicting the next possible user feature representation based on the input feature sequence 310.

For example, during the process of generating the predicted user feature representation 304, the machine learning model 320 may first predict a possible fourth user feature representation 303-1 in the second user feature sequence 331 based on the prefix feature sequence 311. Then, the machine learning model 320 predicts a possible fourth user feature representation 303-2 in the second user feature sequence 331 based on the prefix feature sequence 311 and the first user feature representation 302-1. Next, the machine learning model 320 predicts a possible fourth user feature representation 303-3 in the second user feature sequence 331 based on the prefix feature sequence 311, the first user feature representation 302-1, and the second user feature representation 302-2. By analogy, the machine learning model 320 predicts a possible fourth user feature representation 303-m in the second user feature sequence 331 based on the prefix feature sequence 311, the first user feature representation 302-1, . . . , and the first user feature representation 303-m-1. After that, the machine learning model 320 further predicts a possible third user feature representation 332 attached to the second user feature sequence 331 based on the prefix feature sequence 311, the first user feature representation 302-1, . . . , and the first user feature representation 303-m (i.e., the first user feature sequence 312). Such a third user feature representation 332 may also be referred to as a next user feature representation of the fourth user feature representation 303-1 to the fourth user feature representation 303-m, i.e., a possible fourth user feature representation 303-m+1.

In some embodiments, the fourth user feature representation 303-1 to the fourth user feature representation 303-m and the third user feature representation 332 have the same feature dimensions as the first user feature representation 302-1. For the convenience of discussion, the fourth user feature representation 303-1 to the fourth user feature representation 303-m are also individually or collectively referred to as a fourth user feature representation 303 below.

The inventors have found in research that if the predicted user feature representation 304 is generated directly based on the prefix feature sequence 311 and the first user feature sequence 312, such a predicted user feature representation 304 will be similar to the third user feature representation 332 and have the same feature dimensions as the first user feature representation 302-1. However, the user feature representation (for example, the user feature representation of the user 160) included in a real recommendation request (for example, a recommendation request from the user 160) often has more complex feature dimensions. In order to align the predicted user feature representation 304 with the user feature representation included in the real recommendation request in terms of a feature dimension (which may also be referred to as a feature domain), the embodiments of the present disclosure introduce the classification token 313 into the input feature sequence 310. Through the classification token 313, the machine learning model 320 may incorporate more information into the generation process of the predicted user feature representation 304, thereby obtaining a more complex predicted user feature representation 304, which is then aligned with the user feature representation included in the real recommendation request in terms of the feature dimension.

In some embodiments, the classification token 313 is determined during a training process of the machine learning model 320. Such a classification token 313 may also be referred to as a learnable classification token. In this way, the content recommendation system 150 may encode the prior knowledge for aligning feature dimensions into the machine learning model 320, thereby being able to dynamically guide the machine learning model 320 to generate the predicted user feature representation 304 in an appropriate manner.

In some embodiments, the content recommendation system 150 determines a global feature representation related to at least one of the prefix feature sequence 311 or the first user feature sequence 312 based on the classification token 313. Then, the content recommendation system 150 generates the predicted user feature representation 304 based on the prefix feature sequence 311, the first user feature sequence 312, the third user feature representation, and the global feature representation.

Through the global feature representation, the machine learning model 320 during the generation process of the predicted user feature representation 304 may consider, for example, an association relationship among the plurality of first user feature representations 302, an association relationship between the plurality of first user feature representations 302 and the plurality of object feature representations 301, an association relationship among the plurality of object feature representations 301 themselves, and so on. As an example, the association relationship here includes but is not limited to a causal relationship, etc.

In some embodiments, in response to there being no user sequence associated with the recommendation object, the content recommendation system 150 determines the input feature sequence 310 for the machine learning model 320 based on at least one object feature representation 301.

As an example, in response to there being no user sequence associated with the recommendation object, the content recommendation system 150 determines the input feature sequence 310 for the machine learning model 320 based on at least one object feature representation 301 and the classification token 313 attached to the at least one object feature representation 301.

As described above, the machine learning model 320 may generate the predicted user feature representation 304 by predicting the next possible user feature representation based on the input feature sequence 310. For example, during the process of generating the predicted user feature representation 304, the machine learning model 320 may first predict a possible fourth user feature representation 303-1 in the second user feature sequence 331 based on the prefix feature sequence 311. Then, the machine learning model 320 generates the predicted user feature representation 304 based on the prefix feature sequence 311, the fourth user feature representation 303-1, and the classification token 313. The specific generation process here may be found in the foregoing description, and thus it is not repeated again.

In this way, for a recommendation object, even if there is no user who performs an interaction with the recommendation object, the content recommendation system 150 may use the machine learning model 320 to generate the predicted user feature representation 304 to accurately find out a potential user of the recommendation object. Therefore, the embodiments of the present disclosure may further expand the scope of application of the content recommendation system 150 to the cold start problem.

In some embodiments, the machine learning model 320 may be a machine learning model with a causal attention mechanism. The causal attention mechanism introduces a causal mask 323 to ensure that the machine learning model 320 only relies on the current position and previous information, but not on future information at each position in the output feature sequence 330 (for example, the fourth user feature representation 303, the third user feature representation 332, or the predicted user feature representation 333) during the autoregressive generation operation, thereby maintaining the causality of the data.

As an example, continuing to refer to FIG. 3, for each position of the output feature sequence 330, when calculating attention weights, the causal mask 323 configures a mask 3231 at a position corresponding to future information, so that the weight of the position corresponding to the future information is zero. In this way, the machine learning model 320 may only rely on the current position and previous information when generating each position of the output feature sequence 330.

As an example, continuing to refer to FIG. 3, for the fourth feature representation 303-1, the causal mask 323 configures 3231 at the position of each of the first user feature representations 302 in the first user feature sequence 312 and at the position of the classification token 313. For the fourth feature representation 303-2, the causal mask 323 configures a mask 3231 at the position of all the first user feature representations 302 except the first user feature representation 302-1 in the first user feature sequence 312 and at the position of the classification token 313. For the fourth feature representation 303-3, the causal mask 323 configures a mask 3231 at the positions of all the first user feature representations 302 except the first user feature representation 302-1 and the first user feature representation 302-2 in the first user feature sequence 312 and at the position of the classification token 313. And so on.

In some embodiments, the causal attention mechanism determines a query (Query) feature, a key (Key) feature, and a value (Value) feature based on the input feature sequence 310, and then generates the output feature sequence 330 based on the query feature, the key feature, and the value feature. As an example, continuing to refer to FIG. 3, the content recommendation system 150 may provide the position encoded input feature sequence 310 to the machine learning model 320. After receiving the position encoded input feature sequence 310, the machine learning model 320 calculates the key feature and the value feature through the first neural network layer 321. As an example, the first neural network layer 321 may include a cascaded self-attention layer 3211, a residual connection and normalization layer 3212, a feedforward neural network layer 3213, and a residual connection and normalization layer 3214. As an example, the self-attention layer 3211 may have a self-attention mechanism that may incorporate the causal attention mechanism and prefix information (e.g., the object feature representation 301).

It should be noted that although only one first neural network layer 321 is shown in FIG. 3, the number of the first neural network layer 321 may be 2 or more according to actual needs, and the plurality of first neural network layers 321 may be cascaded in turn, which is not limited in the embodiments of the present disclosure.

As an example, continuing to refer to FIG. 3, the machine learning model 320 may provide the key feature and the value feature output from the first neural network layer 321, together with the query feature, to the second neural network layer 322. As an example, the second neural network layer 322 may include a cascaded self-attention layer 3221, a residual connection and normalization layer 3222, a feedforward neural network layer 3223, and a residual connection and normalization layer 3224. As an example, the self-attention layer 3221 may have a self-attention mechanism that may incorporate the causal attention mechanism and prefix information (e.g., the object feature representation 301).

It should be noted that although only one second neural network layer 321 is shown in FIG. 3, the number of the second neural network layer 322 may be 2 or more according to actual needs, and the plurality of second neural network layers 322 may be cascaded in turn, which is not limited in the embodiments of the present disclosure. The machine learning model 320 may generate the query feature in any appropriate manner, and the embodiments of the present disclosure are not limited thereto.

It should also be noted that the above structure of the machine learning model 320 is only an example, and the machine learning model 320 may also adopt other structures (such as other neural network layers) according to actual needs.

In some embodiments, an encoding process of the input feature sequence 310 by the machine learning model 320 may be expressed by formula (1):

$${p}_{1}^{p} , … {o}_{k}^{p} , {o}_{1}^{u} , … , {o}_{n}^{u} , {o}_{1}^{[ CLS ]} = Encoder ( {p}_{1} , … , {p}_{k} , {u}_{1} , … , {u}_{n} , [ CLS ] ) ) ; \qquad ( 1 )$$

where pᵢ ∈R_{d} and uᵢ ∈R^{d} respectively represent the i-th object feature representation 301 and the i-th first user feature representation 302. CLS∈R^{d} represents the classification token 313, which is attached to the end of the input feature sequence 310.

$${o}_{k}^{i}$$

represents the output of the encoder Encoder of the i-th token of type k (k=p represents the object feature representation 301, k=u represents the first user feature representation 302).

In some embodiments, a decoding process of the machine learning model 320 may be expressed by formula (2).

$${\hat{u}}_{1} , {\hat{u}}_{2} , … , {\hat{u}}_{n + 1} , {\hat{u}}_{next} = Decoder ( q , ( {o}_{1}^{p} , … , {p}_{k}^{p} , {o}_{1}^{u} , … , {o}_{n}^{u} , {o}_{1}^{[ CLS ]} ) ) ; \qquad ( 2 )$$

where q∈R^{(n+2)×d} represents the learnable query feature, ûᵢ∈R^{d}, i∈[1, n] represents the i-th fourth feature representation 303, ûₙ₊₁ ∈R^{d} represents the third user feature representation 332, and ûₙₑₓₜ ∈R^{d} represents the predicted user feature representation 333.

It should be noted that the above formulas and parameters for the encoding process and the decoding process are only examples, and the encoding process and the decoding process may also be expressed by other formulas and parameters according to actual needs.

A training process of the machine learning model 320 is described below. It should be noted that in order to distinguish the inference process from the training process, input and output (for example, the recommendation object, the object feature representation 301, the predicted user feature representation 333, etc.) involved in the inference process are all expressed as corresponding “samples”, that is, in a manner similar to sample recommendation objects, sample object feature representations, predicted sample user feature representations, etc.

In the training process, since the real potential user of the sample recommendation object (that is, the next possible user who performs an interaction predicted by the machine learning model 320 based on the users who have performed interactions with the sample recommendation object, and thus may also be referred to as the next user) may be known, the user most likely to interact with the sample recommendation object may be modeled by maximum likelihood function. This process may be expressed by formula (3):

$$arg max P ( u , {f}_{u} ) \vert model ( \{ {u}_{1} ) , … , ( {u}_{j} ) , … , ( {u}_{n} ) \} , ( i , {f}_{i} ) ) ) ; \qquad ( 3 )$$

where P(⋅) represents the probability distribution function, which indicates a probability that a user u interacts with a sample recommendation object i under given conditions. model(⋅) represents the machine learning model 320, {(u₁), . . . , (uⱼ), . . . , (uₓ)} represents the sample user sequence, fᵢ represents the sample object feature representation of the sample recommendation object i, and fᵤ represents the sample user feature representation of the user u.

In some embodiments, during the training process of the machine learning model 320, a loss function for the training process is determined based on at least one of the following: contrastive loss, cross-entropy loss, and/or auxiliary loss.

The contrastive loss is configured to minimize the distance between similar sample pairs in a feature space, while maximize the distance between dissimilar sample pairs. The cross-entropy loss is configured to measure a difference between two probability distributions, where one probability is a probability distribution predicted by the machine learning model 320, and the other one is a real probability distribution. The objective of the cross-entropy loss is to make the probability distribution predicted by the machine learning model 320 as close to the real probability distribution as possible. The auxiliary loss is an additional loss term added on the basis of a main loss function (such as the contrastive loss and the cross-entropy loss) to assist the training of the machine learning model 320. The auxiliary loss may help the machine learning model 320 better learn features or structures of the data, thereby improving the generalization ability and convergence speed of the model. By combining three loss functions to guide the training of the machine learning model 320, the generation ability of the machine learning model 320 and its robustness in the cold start problem may be enhanced.

In some embodiments, a loss function L_{genreative} for the training process may be expressed by formula (4):

$${ℒ}_{generative} = {λ}_{1} {ℒ}_{contrastive} + {λ}_{2} {ℒ}_{CE} + {λ}_{3} {ℒ}_{auxiliary} ; \qquad ( 4 )$$

where L_{contrasitve} represents the contrastive loss, λ₁ represents the weight of the contrastive loss L_{contrasitve}, L_{CE} represents the cross-entropy loss, λ₂ represents the weight of the cross-entropy loss L_{CE}, L_{auxiliary} represents the auxiliary loss, and λ₃ represents the weight of the auxiliary loss L_{auxiliary}.

In some embodiments, the contrastive loss is configured to increase a similarity between a predicted sample user feature representation generated by the machine learning model 320 and a ground-truth user feature representation and reduce a similarity between the predicted sample user feature representation and a non-ground-truth user feature representation during the training process. The predicted sample user feature representation is generated by the machine learning model 320 based on a training sample related to the ground-truth user feature representation.

As an example, the predicted sample user feature representation may refer to a user feature representation that a potential user (as described above, the potential user may also be referred to as the next user) predicted by the machine learning model 320 for the sample recommendation object in the training process may have. The ground-truth user feature representation may be a user feature representation that a real next user of the sample recommendation object may have. The non-ground-truth user feature representation may be a user feature representation of a user randomly sampled from users who have performed interactions with the sample recommendation object. The training sample related to the ground-truth user feature representation may include, but is not limited to, a sample user feature representation of a user who has performed interactions with the sample recommendation object, a sample object feature representation of the sample recommendation object, a sample classification token, and so on.

For the unspecified content of the predicted sample user feature representation, reference may be made to the description of the predicted user feature representation 333 during the inference process of the machine learning model described above. For the unspecified content of the training sample, reference may be made to the description of the object feature representation 301, the first user feature representation 302, and the classification token 313 during the inference process of the machine learning model described above, and thus details are not repeated here.

In some embodiments, the contrastive loss L_{contrasitve} may be expressed by formula (5):

$${ℒ}_{constrative} = - {\sum }_{i : {R}_{{u}_{i} {\hat{u}}_{i}} = 1} log \frac{exp ( f ( {u}_{i} , {\hat{u}}_{i} ) / τ )}{exp ( f ( {u}_{i} , {\hat{u}}_{i} ) / τ ) + {\sum }_{j \neq i} exp ( f ( {u}_{j} , {\hat{u}}_{i} ) / τ )} ; \qquad ( 5 )$$

where Rᵤ_{ᵢ}_{ûi}=1 represents that after the sample recommendation object is provided to the user corresponding to the i-th sample user feature representation uᵢ, the user performs an interaction with the sample recommendation object. Rᵤ_{ᵢ}_{ûi}=1 may also be referred to as a ground-truth label. ûᵢ represents the predicted sample user feature representation generated by the machine learning model. In the case of Rᵤ_{ᵢ}_{ûi}=1, uᵢ represents the ground-truth user feature representation, uⱼ represents the non-ground-truth user feature representation, f(⋅) represents a similarity function, and τ is a temperature parameter.

In some embodiments, the cross-entropy loss is configured to increase a matching degree between the predicted sample user feature representation generated by the machine learning model 320 and a ground-truth label of the predicted sample user feature representation during the training process. The ground-truth label indicates whether the user performs an interaction with the sample recommendation object after the sample recommendation object is provided to the user.

Since the user feature representations of the users who are impressed to the sample recommendation object but do not perform an interaction with the sample recommendation object (that is, the ground-truth label indicates that the user does not perform an interaction with the sample recommendation object after the sample recommendation object is provided to the user) are also collected, it is impossible to predict which user will perform the next interaction for these user feature representations, and therefore the contrastive loss L_{contrasitve} cannot be used for these user feature representations. However, these samples may pass through a recommendation funnel (including retrieval, pre-ranking, ranking, and re-ranking) and be impressed, which indicates that these samples have relatively high quality and large amount of information compared with the non-ground-truth user feature representation. And the cross-entropy loss L_{CE} may make better use of this information.

In some embodiments, the cross-entropy loss L_{CE} may be expressed by formula (6):

$${ℒ}_{CE} = - ( {\sum }_{i : {R}_{{u}_{i} {\hat{u}}_{i}} = 1} log σ ( f ( {u}_{i} , {\hat{u}}_{i} ) ) + {\sum }_{i : {R}_{{u}_{i} {\hat{u}}_{i}} = 0} log ( 1 - σ ( f ( {u}_{i} , {\hat{u}}_{i} ) ) ) ) ; \qquad ( 6 )$$

where σ(⋅) is a sigmoid function, and Rᵤ_{ᵢ}_{ûi=0} represents that after the sample recommendation object is provided to the user corresponding to the i-th sample user feature representation uᵢ, the user does not perform an interaction with the sample recommendation object.

In some embodiments, the auxiliary loss is configured to increase a matching degree between a prefix sample user feature sequence generated by the machine learning model 320 and the training sample related to the ground-truth user feature representation during the training process. The prefix sample user feature sequence is used by the machine learning model 320 to generate the predicted sample user feature representation.

The prefix sample user feature sequence may be a sample user feature representation that is generated by the machine learning model 320 through the autoregressive generation operation and located before the predicted sample user feature representation. For the specific content of the prefix sample user feature sequence, reference may be made to the description of the fourth sample feature representation 303 and the third sample feature representation 332 during the inference process of the machine learning model described above, and thus details are not repeated here. Through the auxiliary loss, it helps to enhance the learning of the prefix sample user feature sequence by the machine learning model 320.

In some embodiments, the auxiliary loss L_{auxiliary} may be expressed by formula (7):

$${ℒ}_{auxiliary} = ( {\sum }_{i : {R}_{{u}_{i} {\hat{u}}_{i}} = 1} ( {\sum }_{j = 1}^{n + 1} {‖ sg ( {u}_{j} ) - {\hat{u}}_{j} ‖}^{2} ) ; \qquad ( 7 )$$

where sg(⋅) represents that stopping gradient propagation to ûᵢ to prevent the machine learning model 320 from collapsing.

In some embodiments, the machine learning model 320 is updated through an online learning process, and the predicted user feature representation 304 for the recommendation object is updated using the updated machine learning model 320.

Online learning is a machine learning paradigm. Unlike traditional batch learning, online learning does not need to collect a large amount of training data at one time, but may update the model immediately when new data arrives. In online learning, the machine learning model 320 may continuously receive new sample data and adjust its own parameters according to the new data, so as to gradually optimize the performance of the machine learning model 320. In the embodiments of the present disclosure, reference may be made to the description of the model training described above for the online learning process of the machine learning model 320, and thus details are not repeated here.

Once the predicted user feature representation 304 of the recommendation object is determined, the content recommendation system 150 may store the predicted user feature representation 304 and wait for recommendation requests from other users. Referring back to FIG. 2, at block 230, in response to receiving a recommendation request, the content recommendation system 150 extracts a second user feature representation corresponding to an initiating user of the recommendation request.

As an example, the recommendation request may be initiated through various channels. For example, in a mobile application, when the user opens a home page of the application, enters a specific section (such as a video classification section), or clicks a “Get Recommendation” button, the application may send a recommendation request to the content recommendation system 150. On a web page end, browsing a specific page or performing certain operations (such as searching for keywords) by the user may also trigger the recommendation request.

As an example, the second user feature representation may be a vector or a numerical value obtained after encoding user features of the initiating user of the recommendation request. In addition to the user features that may be indicated by the first user feature representation, the second user feature representation may also indicate more complex user features. As an example, the content recommendation system 150 may encode these user features into the second user feature representations matching with the predicted user feature representations 333 through embedding techniques, feature engineering, or any appropriate algorithm, so that the content recommendation system 150 may perform association processing on the predicted user feature representation 333 and the second user feature representation. As an example, a hierarchical navigable small world graph.

At block 240, the content recommendation system 150 provides the recommendation object to the initiating user of the recommendation request in response to a similarity between the second user feature representation and the predicted user feature representation 304 satisfying a similarity requirement.

As an example, after extracting the second user feature representation, the content recommendation system 150 may determine, based on any appropriate search algorithm, similarities between the second user feature representation and predicted user feature representations 304 of respective pre-stored recommendation objects. Then, the content recommendation system 150 finds, from these pre-stored predicted user feature representations 304, a predicted user feature representation 304 similar to the second user feature representation based on whether the similarity satisfy the similarity requirement (for example, the similarity is higher than a predetermined similarity threshold). Then, the content recommendation system 150 provides a recommendation object corresponding to the found predicted user feature representation 304 to the initiating user of the recommendation request.

As an example, the search algorithm includes, but is not limited to, a hierarchical navigable small world (HNSW) algorithm, etc. The HNSW is an efficient approximate nearest neighbor search (ANN) algorithm, which is particularly suitable for similarity retrieval of large-scale and high-dimensional data sets. It is based on the concept of small world networks, and achieves fast and efficient search by constructing a multi-level graph structure and calculating dot products.

It may be clearly understood according to the embodiments described above that the embodiments of the present disclosure define users a user sequence with positive interactions (features of these interactions have, for example, a same degree of sparsity) as seed users, and construct the first user feature sequence 312 through the real-time fine-grained first user feature representations 302. In this way, the real-time dynamic interaction information is introduced into the first user feature sequence 312, thereby enhancing the relatively weak user feature representations in the cold start problem. In addition, the embodiments of the present disclosure enable the first user feature sequence 312 to have a characteristic of temporal order, thereby helping the machine learning model 320 to better learn the causal relationship among the plurality of first user feature representations 302, and improving the accuracy of generating the predicted user feature representation 304. To overcome the limitation that the machine learning model 320 only relies on the first user feature sequence 312, the embodiments of the present disclosure further integrate the object feature representation 301 of the recommendation object as prefix prompts embedding to enhance the first user feature sequence 312, thereby assisting in generating the predicted user feature representation 304. Moreover, the embodiments of the present disclosure further introduce a learnable classification token, thereby being able to bridge the gap between the predicted user feature representation 304 and the user feature representation in a real recommendation request in terms of a feature domain.

Further, the embodiments of the present disclosure use a Transformer architecture based machine learning model, and design three dedicated loss functions to model the generation process of the predicted user feature representation 304 (which may also be referred to as the user feature representation of the next user). The contrastive loss function may transform discrete entity prediction into entity feature representation learning. Through the cross-entropy loss function, the embodiments of the present disclosure may use those training samples that have impressions but no interactions. Through the auxiliary loss function, it may enhance the learning of user feature representation by the machine learning model. These designs enable the generated predicted user feature representation 304 to seamlessly integrate with the HNSW search algorithm.

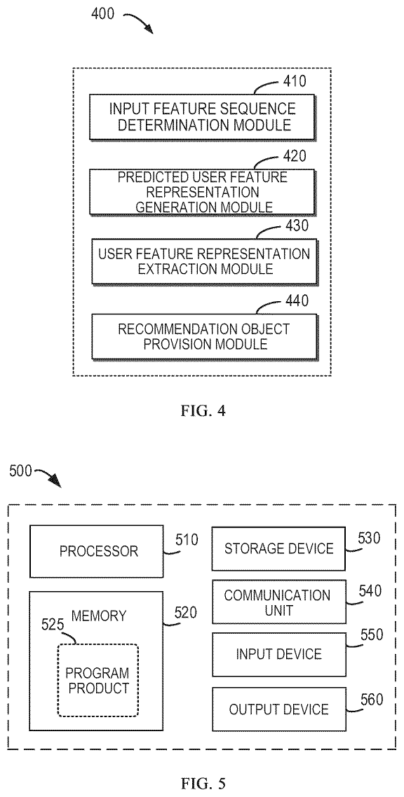

The embodiments of the present disclosure further provide a corresponding apparatus for implementing the above method or process. FIG. 4 illustrates a schematic structural block diagram of an apparatus 400 for information processing according to some embodiments of the present disclosure. The apparatus 400 may be implemented as the content recommendation system 150 or included in the content recommendation system 150. Each module/component in the apparatus 400 may be implemented by hardware, software, firmware, or any combination thereof.

Referring to FIG. 4, the apparatus 400 includes an input feature sequence determination module 410, a predicted user feature representation generation module 420, a user feature representation extraction module 430, and a recommendation object provision module 440. The input feature sequence determination module 410 is configured to determine, in response to there being a user sequence associated with a recommendation object, an input feature sequence for a machine learning model based on at least one object feature representation of the recommendation object and at least one first user feature representation corresponding to at least one user in the user sequence, where the user sequence is determined based on users who perform interactions with the recommendation object. The predicted user feature representation generation module 420 is configured to generate, based on the input feature sequence, a predicted user feature representation for the recommendation object using the machine learning model, the predicted user feature representation is used to indicate a user who performs an interaction with the recommendation object at a future time. The user feature representation extraction module 430 is configured to extract, in response to receiving a recommendation request, a second user feature representation corresponding to an initiating user of the recommendation request. The recommendation object provision module 440 is configured to provide, in response to a similarity between the second user feature representation and the predicted user feature representation satisfying a similarity requirement, the recommendation object to the initiating user of the recommendation request.

In some embodiments, the input feature sequence determination module 410 is further configured to: obtain a first user feature sequence by ranking, based on execution time of the interaction, the at least one first user feature representation; determine, based on the at least one object feature representation, a prefix feature sequence for the first user feature sequence; and determine the input feature sequence based at least on a concatenation of the prefix feature sequence and the first user feature sequence.

In some embodiments, the input feature sequence determination module 410 is further configured to: determine the input feature sequence based on a concatenation of the prefix feature sequence, the first user feature sequence, and a classification token associated with the machine learning model, where the classification token is attached to the prefix feature sequence and the first user feature sequence. The predicted user feature representation generation module 420 is further configured to: using the machine learning model, perform, based on the prefix feature sequence and the first user feature sequence, an autoregressive generation operation for user feature representation to generate a second user feature sequence corresponding to the first user feature sequence and a third user feature representation attached to the second user feature sequence; and generate the predicted user feature representation based on the classification token, the prefix feature sequence, the first user feature sequence, and the third user feature representation.

In some embodiments, the predicted user feature representation generation module 420 is further configured to: determine, based on the classification token, a global feature representation related to at least one of the prefix feature sequence or the first user feature sequence; and generate the predicted user feature representation based on the prefix feature sequence, the first user feature sequence, the third user feature representation, and the global feature representation.

In some embodiments, the classification token is determined during a training process of the machine learning model.

In some embodiments, the machine learning model is updated through an online learning process, and the predicted user feature representation for the recommendation object is updated using the updated machine learning model.

In some embodiments, the input feature sequence determination module 410 is further configured to: determine, in response to there being no user sequence associated with the recommendation object, the input feature sequence for the machine learning model based on the at least one object feature representation.

In some embodiments, the apparatus 400 further includes a user sequence determination module. The user sequence determination module is configured to: select, from candidate users who perform the interactions with the recommendation object, a predetermined number of candidate users whose execution times of the interactions satisfy a time requirement to be users in the user sequence.

In some embodiments, during a training process of the machine learning model, a loss function for the training process is determined based on at least one of the following: contrastive loss, cross-entropy loss, and/or auxiliary loss.

In some embodiments, the contrastive loss is configured to increase a similarity between a predicted sample user feature representation generated by the machine learning model and a ground-truth user feature representation and reduce a similarity between the predicted sample user feature representation and a non-ground-truth user feature representation during the training process, where the predicted sample user feature representation is generated by the machine learning model based on a training sample related to the ground-truth user feature representation. The cross-entropy loss is configured to increase a matching degree between the predicted sample user feature representation generated by the machine learning model and a ground-truth label of the predicted sample user feature representation during the training process, where the ground-truth label indicates whether a user performs an interaction with a sample recommendation object after the sample recommendation object is provided to the user. The auxiliary loss is configured to increase a matching degree between a prefix sample user feature sequence generated by the machine learning model and the training sample related to the ground-truth user feature representation during the training process, where the prefix sample user feature sequence is used by the machine learning model to generate the predicted sample user feature representation.

FIG. 5 illustrates a block diagram of an electronic device 500 in which one or more embodiments of the present disclosure may be implemented. The electronic device 500 may be used, for example, to implement the content recommendation system 150 shown in FIG. 1 or the apparatus 400 shown in FIG. 4. It should be appreciated that the electronic device 500 shown in FIG. 5 is merely an example and should not constitute any limitation to the function and scope of the embodiments described herein.

Referring to FIG. 5, the electronic device 500 is in a form of a general-purpose electronic device. Components of the electronic device 500 may include, but are not limited to, one or more processors 510, a memory 520, a storage device 530, one or more communication units 540, one or more input devices 550, and one or more output devices 560. The processor 510 may be an physical or virtual processor and may execute various processes based on programs stored in the memory 520. In a multi-processor system, a plurality of processors execute computer-executable instructions in parallel to improve the parallel processing capability of the electronic device 500.

The electronic device 500 typically includes a plurality of computer storage media. Such medium may be any available medium accessible by the electronic device 500, including but not limited to volatile and non-volatile medium, removable and non-removable medium. The memory 520 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be a removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, it is possible to provide a disk drive for reading from a removable and non-volatile disk (such as a “floppy disk”) or writing into a removable and non-volatile disk, and an optical disk drive for reading from a removable and non-volatile optical disk or writing into a removable and non-volatile optical disk. In these cases, each drive may be connected to a bus (not shown) by one or more data medium interfaces. The memory 520 may include a computer program product 525, which has one or more program modules configured to perform various methods or acts of various embodiments of the present disclosure.

The communication unit 540 enables communication with other electronic devices through a communication medium. Additionally, the functions of the components of the electronic device 500 may be implemented with a single computing cluster or a plurality of computing machines, which may communicate through communication connections. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may also communicate with one or more external devices (not shown) as needed through the communication unit 540, the external devices such as a storage device, a display device, etc., communicate with one or more devices that enable the user to interact with the electronic device 500, or communicate with any devices (such as a network card, a modem, etc.) that enable the electronic device 500 to communicate with one or more other electronic devices. Such communication may be performed via input/output (I/O) interfaces (not shown).

According to an example implementation of the present disclosure, a computer-readable storage medium is provided, the computer-readable storage medium has computer-executable instructions stored thereon, where the computer-executable instructions are executed by a processor to implement the method described above. According to an example implementation of the present disclosure, a computer program product is further provided, the computer program product is tangibly stored on a non-transitory computer-readable medium and includes computer-executable instructions, where the computer-executable instructions are executed by a processor to implement the method described above.

Aspects of the present disclosure are described herein with reference to a flowchart and/or block diagrams of methods, apparatuses, devices, and computer program products implemented according to the present disclosure. It should be appreciated that each block of the flowchart and/or block diagrams, and each combination of blocks in the flowchart and/or block diagrams, may be implemented by computer-readable program instructions.

These computer-readable program instructions may be provided to a processor of a general-purpose computer, a special-purpose computer, or other programmable data processing apparatus to produce a machine, such that these instructions, when executed by the processor of the computer or other programmable data processing apparatus, produce an apparatus for implementing the functions/acts specified in one or more blocks of the flowchart and/or block diagrams. These computer-readable program instructions may also be stored in a computer-readable storage medium, these instructions enable the computer, the programmable data processing apparatus, and/or other devices to work in a specific way, and thus, the computer-readable medium storing the instructions includes a manufacture, which includes instructions for implementing various aspects of the functions/acts specified in one or more blocks of the flowchart and/or block diagrams.

The computer-readable program instructions may be loaded onto a computer, other programmable data processing apparatuses, or other devices, so that a series of operations and steps are performed on the computer, other programmable data processing apparatuses, or other devices to produce a computer-implemented process, which makes the instructions executed on the computer, other programmable data processing apparatuses, or other devices implement the functions/acts specified in one or more blocks of the flowchart and/or block diagrams.

The flowchart and block diagrams in the drawings show the possibly implemented architectures, functions, and operations of the system, method, and computer program product according to a plurality of implementations of the present disclosure. In this regard, each block in the flowchart or block diagrams may represent a module, a program segment, or a part of instructions, and the module, the program segment, or the part of instructions contains one or more executable instructions for implementing the specified logical functions. In some alternative implementations, functions marked in the blocks may also occur in an order different from the order marked in the drawings. For example, two consecutive blocks may actually be performed substantially in parallel, or they may sometimes be performed in a reverse order, depending on the functions involved. It should also be noted that each block in the block diagrams and/or flowchart, and the combination of the blocks in the block diagrams and/or flowchart, may be implemented with a special-purpose hardware-based system that executes specified functions or acts, or may be implemented with a combination of special-purpose hardware and computer instructions.

The implementations of the present disclosure have been described above. The above description is for example, non-exhaustive, and is not limited to the disclosed implementations. Without departing from the scope and spirit of the illustrated implementations, many modifications and variations will be apparent to those of ordinary skill in the art. Determination of the terms used herein is intended to best explain principles, practical applications, or improvements to the technologies in the market of the implementations, or to enable other ordinary skilled persons in the art to understand the implementations disclosed herein.

1. A method for information processing, comprising:
determining, in response to there being a user sequence associated with a recommendation object, an input feature sequence for a machine learning model based on at least one object feature representation of the recommendation object and at least one first user feature representation corresponding to at least one user in the user sequence, wherein the user sequence is determined based on users who perform interactions with the recommendation object;
generating, based on the input feature sequence, a predicted user feature representation for the recommendation object using the machine learning model, wherein the predicted user feature representation is used to indicate a user who performs an interaction with the recommendation object at a future time;
extracting, in response to receiving a recommendation request, a second user feature representation corresponding to an initiating user of the recommendation request; and
providing, in response to a similarity between the second user feature representation and the predicted user feature representation satisfying a similarity requirement, the recommendation object to the initiating user of the recommendation request.

2. The method of claim 1, wherein determining the input feature sequence for the machine learning model comprises:
obtaining a first user feature sequence by ranking, based on execution time of the interaction, the at least one first user feature representation;
determining, based on the at least one object feature representation, a prefix feature sequence for the first user feature sequence; and
determining the input feature sequence based at least on a concatenation of the prefix feature sequence and the first user feature sequence.

3. The method of claim 2, wherein determining the input feature sequence based at least on the concatenation of the prefix feature sequence and the first user feature sequence comprises:
determining the input feature sequence based on a concatenation of the prefix feature sequence, the first user feature sequence, and a classification token associated with the machine learning model, wherein the classification token is attached to the prefix feature sequence and the first user feature sequence; and
wherein generating the predicted user feature representation for the recommendation object comprises: using the machine learning model,
performing, based on the prefix feature sequence and the first user feature sequence, an autoregressive generation operation for user feature representation to generate a second user feature sequence corresponding to the first user feature sequence and a third user feature representation attached to the second user feature sequence, and
generating the predicted user feature representation based on the classification token, the prefix feature sequence, the first user feature sequence, and the third user feature representation.

4. The method of claim 3, wherein generating the predicted user feature representation based on the classification token, the prefix feature sequence, the first user feature sequence, and the third user feature representation comprises:
determining, based on the classification token, a global feature representation related to at least one of the prefix feature sequence or the first user feature sequence; and
generating the predicted user feature representation based on the prefix feature sequence, the first user feature sequence, the third user feature representation, and the global feature representation.

5. The method of claim 3, wherein the classification token is determined during a training process of the machine learning model.

6. The method of claim 1, wherein the machine learning model is updated through an online learning process, and the predicted user feature representation for the recommendation object is updated using the updated machine learning model.

7. The method of claim 1, further comprising:
determining, in response to there being no user sequence associated with the recommendation object, the input feature sequence for the machine learning model based on the at least one object feature representation.

8. The method of claim 1, wherein the user sequence is determined by:
selecting, from candidate users who perform the interactions with the recommendation object, a predetermined number of candidate users whose execution times of the interactions satisfy a time requirement to be users in the user sequence.

9. The method of claim 1, wherein during a training process of the machine learning model, a loss function for the training process is determined based on at least one of the following:
contrastive loss,
cross-entropy loss, or
auxiliary loss.

10. The method of claim 9, wherein,
the contrastive loss is configured to increase a similarity between a predicted sample user feature representation generated by the machine learning model and a ground-truth user feature representation and reduce a similarity between the predicted sample user feature representation and a non-ground-truth user feature representation during the training process, wherein the predicted sample user feature representation is generated by the machine learning model based on a training sample related to the ground-truth user feature representation;
the cross-entropy loss is configured to increase a matching degree between the predicted sample user feature representation generated by the machine learning model and a ground-truth label of the predicted sample user feature representation during the training process, wherein the ground-truth label indicates whether a user performs an interaction with a sample recommendation object after the sample recommendation object is provided to the user; and
the auxiliary loss is configured to increase a matching degree between a prefix sample user feature sequence generated by the machine learning model and the training sample related to the ground-truth user feature representation during the training process, wherein the prefix sample user feature sequence is used by the machine learning model to generate the predicted sample user feature representation.

11. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
determining, in response to there being a user sequence associated with a recommendation object, an input feature sequence for a machine learning model based on at least one object feature representation of the recommendation object and at least one first user feature representation corresponding to at least one user in the user sequence, wherein the user sequence is determined based on users who perform interactions with the recommendation object;
generating, based on the input feature sequence, a predicted user feature representation for the recommendation object using the machine learning model, wherein the predicted user feature representation is used to indicate a user who performs an interaction with the recommendation object at a future time;
extracting, in response to receiving a recommendation request, a second user feature representation corresponding to an initiating user of the recommendation request; and
providing, in response to a similarity between the second user feature representation and the predicted user feature representation satisfying a similarity requirement, the recommendation object to the initiating user of the recommendation request.

12. The electronic device of claim 11, wherein determining the input feature sequence for the machine learning model comprises:
obtaining a first user feature sequence by ranking, based on execution time of the interaction, the at least one first user feature representation;
determining, based on the at least one object feature representation, a prefix feature sequence for the first user feature sequence; and
determining the input feature sequence based at least on a concatenation of the prefix feature sequence and the first user feature sequence.

13. The electronic device of claim 12, wherein determining the input feature sequence based at least on the concatenation of the prefix feature sequence and the first user feature sequence comprises:
determining the input feature sequence based on a concatenation of the prefix feature sequence, the first user feature sequence, and a classification token associated with the machine learning model, wherein the classification token is attached to the prefix feature sequence and the first user feature sequence; and
wherein generating the predicted user feature representation for the recommendation object comprises: using the machine learning model,
performing, based on the prefix feature sequence and the first user feature sequence, an autoregressive generation operation for user feature representation to generate a second user feature sequence corresponding to the first user feature sequence and a third user feature representation attached to the second user feature sequence, and
generating the predicted user feature representation based on the classification token, the prefix feature sequence, the first user feature sequence, and the third user feature representation.

14. The electronic device of claim 13, wherein generating the predicted user feature representation based on the classification token, the prefix feature sequence, the first user feature sequence, and the third user feature representation comprises:
determining, based on the classification token, a global feature representation related to at least one of the prefix feature sequence or the first user feature sequence; and
generating the predicted user feature representation based on the prefix feature sequence, the first user feature sequence, the third user feature representation, and the global feature representation.

15. The electronic device of claim 13, wherein the classification token is determined during a training process of the machine learning model.

16. The electronic device of claim 11, wherein the machine learning model is updated through an online learning process, and the predicted user feature representation for the recommendation object is updated using the updated machine learning model.

17. The electronic device of claim 11, wherein the acts further comprise:
determining, in response to there being no user sequence associated with the recommendation object, the input feature sequence for the machine learning model based on the at least one object feature representation.

18. The electronic device of claim 11, wherein the user sequence is determined by:
selecting, from candidate users who perform the interactions with the recommendation object, a predetermined number of candidate users whose execution times of the interactions satisfy a time requirement to be users in the user sequence.

19. The electronic device of claim 11, wherein during a training process of the machine learning model, a loss function for the training process is determined based on at least one of the following:
contrastive loss,
cross-entropy loss, or
auxiliary loss.

20. A non-transitory computer-readable storage medium having computer-executable instructions stored thereon, the computer-executable instructions being executable by a processor to perform acts comprising:
determining, in response to there being a user sequence associated with a recommendation object, an input feature sequence for a machine learning model based on at least one object feature representation of the recommendation object and at least one first user feature representation corresponding to at least one user in the user sequence, wherein the user sequence is determined based on users who perform interactions with the recommendation object;
generating, based on the input feature sequence, a predicted user feature representation for the recommendation object using the machine learning model, wherein the predicted user feature representation is used to indicate a user who performs an interaction with the recommendation object at a future time;
extracting, in response to receiving a recommendation request, a second user feature representation corresponding to an initiating user of the recommendation request; and
providing, in response to a similarity between the second user feature representation and the predicted user feature representation satisfying a similarity requirement, the recommendation object to the initiating user of the recommendation request.
